(19) United States
(12) Patent Application Publication
(10) Pub. No.: US 2006/0072404 A1
(43) Pub. Date: Apr. 6, 2006

(54) Method and system for managing data storage on optical media using scan-before-burn techniques

(76) Inventors: Donald B. Gage, Cedar Park, TX (US); Christiaan Steenbergen, Austin, TX (US)

Correspondence Address: HAMILTON & TERRILE, LLP, P.O. BOX 203518, AUSTIN, TX, 78720, US

(21) Appl. No.: 10/935,445

(22) Filed: Sep. 7, 2004

(51) Int. Cl. G11B 19/00; G11B 5/09

(52) U.S. Cl. 369/47.5; 369/53.1; 369/47.1

(57) ABSTRACT

A method and system for reducing errors when storing data on a marginal optical storage media. Write parameters for writing information to the optical storage media are adjusted to compensate in the quality of the storage media. In one embodiment of the invention, the drive uses a scan-before-burn routine to scan the optical storage media prior to writing to it, thereby determining whether or not the media has defects. This scan information is then used to determine how slow or fast the drive is capable of writing to the media. The scan can be triggered by the user at any time or may be triggered by the optical storage device if the media is not recognized by the firmware used to control the drive. In an alternate embodiment of the invention, the scan-before-burn routine is implemented only after a write failure. In this embodiment of the invention, the drive control software records the optical storage media type by media ID start code when a write error is detected. The next time optical media with the same media ID start code is inserted into the drive for recording, the user is reminded that this media had a write failure associated with it. The user at this time will be will be provided with an opportunity to perform the scan-before-burn routine.

### BACKGROUND OF THE INVENTION

1. Field of the Invention

The present invention relates in general to the field of optical storage media, and more particularly to a method and system for detecting errors and managing data storage on optical storage media using scan-before-burn techniques.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. Information handling systems continually improve in the ability of both hardware components and software applications to generate and manage information.

As the amount of information generated by information handling systems increases, storage of information presents an increased challenge. One solution for storing information in removable media is provided by optical storage media, such as CD-RW and DVD+RW, which manage information in much the same manner as magnetic floppy disks. Today, a majority of the optical media is recordable, “write-once” media. CD-RW/Combo/DVD+R/RW devices and re-writable media for these devices are also increasing in popularity.

Media manufacturers are having problems keeping up with the demand for optical storage media and the manufacturing of optical storage media does not always generate high quality media. The lowest quality optical storage media is often used because it is cheapest. All recordable optical storage media, regardless of type, is uniquely identified by a code embedded in the media. This code identifies the manufacturer and disc type. In the case of CD-type media, it is called an ATIP start code, but it can more generally be called a “media ID.” Additional embedded media ID information also identifies the material used in the substrate, recommended laser power setting and recommended recording speed. It does not, however, identify the marginality of the optical storage media. The lowest quality optical storage media will vary in marginality between disc manufacturers. This marginality is mostly evident in focusing and tracking errors. The writer will not always be aware while burning, that the optical storage media contains these errors. Therefore, the control firmware will cause the writer to continue writing at the maximum allowed speed indicated by the media ID, thereby increasing the probability of write errors.

Previous approaches for determining the quality of optical storage media have involved measurement of the embedded clock in the disc, called the “wobble signal.” However, this technique is generally chipset dependent. A technique referred to as “Just Speed” has been proposed by Ricoh Corporation as a method to reduce disc errors such as insufficient power in writing and servo-follow error. In this method, the mechanism controls the maximum writing speed by (1) using the media ID information (maker name, model number, etc. pre-recorded on disc), (2) performing test writing to and area (OPC) at the inner circumference of the disc, (3) getting the status of the servo follow check of the outer circumference of the disc (checking of track shift due to lack of precision in cutting of the disc itself). A combination of the above (1), (2), and (3) enables better certainty in high-speed writing, while offering support to discs where maximum writing speed cannot be obtained from the media ID information.

### SUMMARY OF THE INVENTION

In view of the foregoing, it is clear that a need has arisen for a method and system which detects optical storage media errors and automatically adjusts system parameters to optimize data storage based on the quality of the optical storage media.

In accordance with the present invention, a method and system are provided which substantially reduce the disadvantages and problems associated with previous methods and systems for recording information on optical storage media. In the present invention, write parameters for writing information to the optical storage media are adjusted to compensate in the quality of the storage media. In one embodiment of the invention, the drive scans the optical storage media prior to writing to it, thereby determining whether or not the media has errors. This scan information is then used to determine how slow or fast the drive is capable of writing to the media. This scan, sometimes referred to hereinbelow as “scan-before-burn,” can be triggered by the user at any time or may be triggered by the drive if the media is not recognized by the firmware used to control the drive.

In an alternate embodiment of the invention, the scan-before-burn technique is implemented only after a write failure. In this embodiment of the invention, the drive control software records the optical storage media type by media ID start code when a write error is detected. The next time optical media with the same media ID start code is inserted into the drive for recording, the user is reminded that this media had a write failure associated with it. The user at this time will be provided with an opportunity to perform the scan-before-burn routine.

The scan-before-burn technique of the present invention can be implemented by checking errors in the following parameters that are available to the drive electronics: a) radial contrast before recording, b) wobble amplitude and/or address, c) reflectivity, d) focus errors, and e) tracking errors. Those of skill in the art will recognize that the advantages and benefits of the method and system of the present invention is not limited to detection of the aforementioned parameters, but can be implemented by monitoring a variety of other performance parameters related to optical storage media.

The present invention is not limited to a specific chipset or method of error checking. Moreover, the present invention can be easily implemented on a wide variety of optical storage devices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of an information handling system comprising an optical storage device operable to implement the present invention for reducing data errors and optimizing optical media write speed; and

FIG. 2 is a flow diagram of the processing steps for implementing an embodiment of the present invention.

### DETAILED DESCRIPTION

In the method and system of the present invention the optical quality parameters of optical storage media are determined using various embodiments of a scan-before-burn technique described in greater detail hereinbelow. The optical quality parameters are then used by an information handling system to control the write speed for storing information on the optical storage media. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

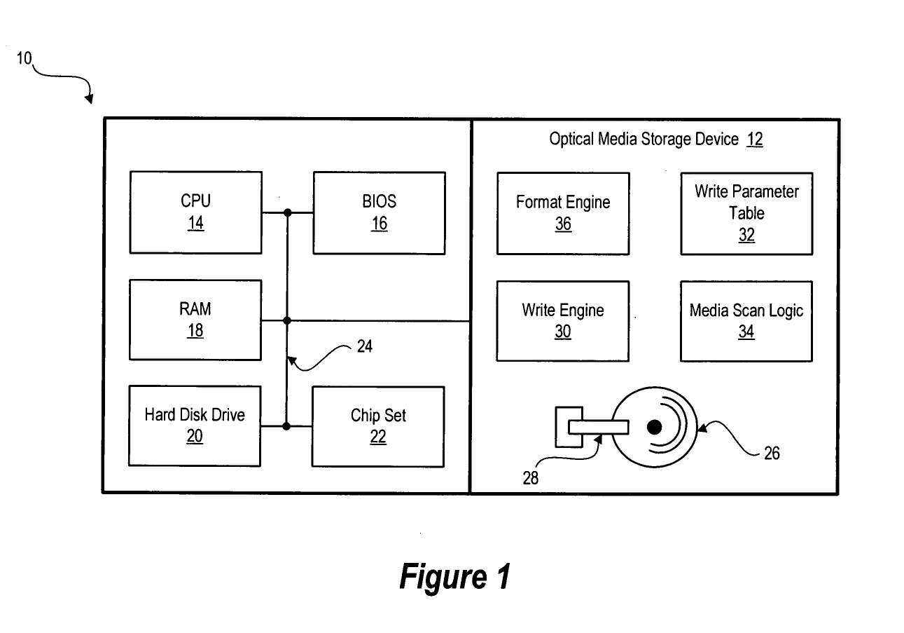

FIG. 1 is an illustration of a system block diagram of an information handling system including an optical media storage device 12. The optical media storage device is broadly comprised of a laser 28, media scan logic 34, format engine 36, write engine 30, and a write parameter table 32. The media scan logic 34 is operable to detect optical storage media defects and to control the write speed to reduce errors, as will be described in greater detail hereinbelow. The information handling system 10 includes components that generate information for storage on optical storage media 26 by optical media storage device 12. For instance, applications running on a CPU 14 coordinate with BIOS 16, RAM 18, hard disk drive 20, and chip set 22 to transfer generated information through bus 24 to optical media storage device 12 for storage on optical media 26. A focused laser 28 moves across optical media 26 to write generated information by pulsing a focused laser beam in specific sequences with a selectively set pulse intensity and duration. The focused laser beam “burns” the information onto the optical storage media as a string of data points having varying reflectivity and/or duration readable as information by focused laser 28 at a low power.

Optical storage media 26 has a recording layer that can be made of various materials. Focused laser 28 alters the material by changing the reflective optical properties to record the information. A write engine 30 selects write parameters for focused laser 28 to heat the media material to produce desired reflectivity properties. A write parameter table 32 stores write parameters associated with different types of disks or materials so that focused laser 28 writes information with an appropriate laser beam. For instance, write parameters include write power, pulse width, timing and step power. The write engine 30 controls the various write parameters, including write speed, that are used to transfer data to the optical storage medium 26. The write engine 30 is also operable to detect write errors and to trigger the scan-before-burn routine in response thereto.

As will be understood by those of skill in the art, the speed at which data can be accurately written is limited by the quality of the optical storage media 26. In various embodiments of the present invention, media scan logic 34 is used to scan the optical storage media 26 prior to writing data to determine the quality of the optical storage media 26. The media scan logic 34 thereby obtains storage media performance parameters that can be used by the write engine 30 to control the write speed that is used to transfer data to the optical storage media 26 with a minimal error rate.

In one embodiment of the present invention, the media scan logic 34 scans the optical storage media 26 prior to writing to it, thereby determining whether or not the media has errors. This scan information is then used to determine how slow or fast the drive is capable of writing to the media without incurring a significant number of write errors. This scan can be triggered by the user at any time or may be triggered by the drive if the media is not recognized by the firmware used to control the drive.

In an alternate embodiment of the invention, the scan-before-burn technique is implemented only after a write failure. In this embodiment of the invention, the drive control software records the optical storage media type by media ID start code when a write error is detected. The next time optical media with the same media ID start code is inserted into the drive for recording, the user is reminded that this media had a write failure associated with it. The user will then be asked whether the scan-before-burn routine should be executed.

In the present invention, “scan-before-burn” refers to a routine that is implemented by the media scan logic 34 for media that is either unrecognized by the optical recorder or has had a write failure associated to it. The scan-before-burn routine can detect, but is not limited to detecting, errors in the following parameters: a) radial contrast before recording (related to the amplitude of the signal generated when the laser crosses tracks on the disc), b) wobble address error rate, c) reflectivity, d) focus errors, and e) tracking errors (push-pull or other tracking signals amplitude deviations).

Utilizing a mixture of some or all of these error checks, the write engine 30 can determine which (lower) burn speed has the highest probability of ensuring the optical recording is as error free as possible. This speed will become the new supported writing speed for that particular piece of optical storage media. Recording laser power will be adjusted using the write parameter table or using a generic write strategy based on the new optimal write speed. The manner in which various suppliers of optical recorders support their device's ability to scan blank media will be different; however, it is possible to implement the present invention in virtually any optical media drive by using a bit in the control software that can be turned “on” or “off” and that can be implemented through an ATAPI command.

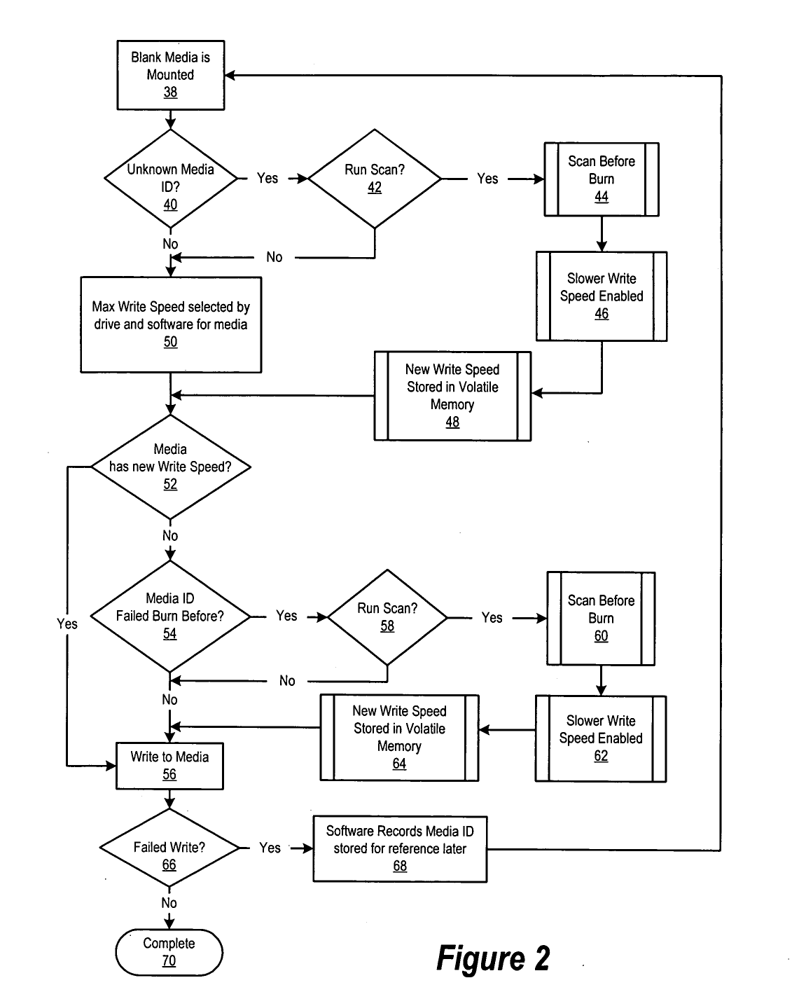

Referring now to FIG. 2, a flow diagram illustrates a process for using scan-before-burn techniques to optimize the write speed for transferring data to marginal optical storage media. The process begins at step 38 with detection of optical storage media for the writing of information inserted in the optical media storage device. At step 40, a test is conducted to determine whether the optical storage media has an unknown media ID. If the result of the test conducted in step 40 indicates that the media ID is unknown, processing proceeds to step 42 where a decision is made—either by the user or automatically by the optical drive control—whether to run a scan of the media. If the result of the decision in step 42 is to run a scan, processing proceeds to step 44 where the scan-before-burn routine is run, followed by a lowering of the write speed in step 46. In step 48, the new write speed is stored in volatile memory. If the decisions in steps 40 or 42 result in no scan being conducted, the maximum write speed for the optical storage media will be selected in step 50. If however, the scan-before-burn routine is run, the lower write speed stored in volatile memory in step 48 will be used for writing data to the optical storage media.

In step 52 a test is conducted to determine if a new write speed has been selected. If the results of the test conducted in step 52 indicate that a new write speed has been selected, processing proceeds to step 56 where the new write speed is used to transfer data to the optical storage media. If, however, the results of the test conducted in step 52 indicate that no new write speed has been selected, processing proceeds to step 54 where a test is conducted to determine whether the optical storage media has a media ID that has failed to burn correctly before. If the result of the test conducted in step 54 indicates that the optical storage media has a media ID that has failed to burn before, processing proceeds to step 58 where a decision is made—either by the user or automatically by the optical drive control—whether to run a scan of the media. If the result of the decision in step 58 is to run a scan, processing proceeds to step 60 where the scan-before-burn routine is run, followed by a lowering of the write speed in step 62. In step 64, the new write speed is stored in volatile memory. If the decisions in steps 54 or 58 result in no scan being conducted, the existing write speed for the optical storage media will be used and processing proceeds to step 56 where the existing write speed is used to write data to the optical storage media. If however, the scan-before-burn routine is run, the lower write speed stored in volatile memory in step 64 will be used for writing data to the optical storage media in step 56. In step 66 a test is conducted to determine whether the optical media failed to write correctly. If the results of the test conducted in step 66 indicates that there was no write failure, processing proceeds to step 70 and processing is complete. If, however, the result of the test conducted in step 66 indicates that there was a failure to write correctly, processing proceeds to step 68 where the media ID of the storage media is stored for future reference. Processing then returns to step 38 followed by the subsequent processing steps as discussed hereinabove.

The present invention is not limited to a specific chipset or method of error checking and can be easily implemented on a wide variety of optical storage devices. Furthermore, the present invention can be used to reduce the amount of updates applied to the optical drive control firmware due to marginal media related issues. The added cost for scan-before-burn is minimal because most optical devices support the requirement of focus error detection in some form or another. Those of skill in the art will recognize that the advantages and benefits of the method and system of the present invention is not limited to detection of the aforementioned parameters, but can be implemented by monitoring a variety of other performance parameters related to optical storage media.

Although the present invention has been described in detail, it should be understood that various changes, substitutions and alterations can be made hereto without departing from the spirit and scope of the invention as defined by the appended claims.

What is claimed is:

1. An information handling system for writing information to an optical media, the information handling system comprising:
components operable to generate information;
an optical storage device operable to write the generated information to the optical storage media with selectable write parameters; and
scan control logic operable to implement a scan-before-burn procedure to detect the optical quality of an optical storage media and to adjust the write speed of said optical storage device to minimize errors in the transfer of data to said optical storage media.

2. The information handling system of claim 1 wherein the scan control logic uses media ID information stored on said optical storage media to perform said scan-before-burn procedure.

3. The information handling system of claim 1 wherein the optical storage media comprises write-once media.

4. The information handling system of claim 3 wherein the optical storage media comprises a write-once DVD disc.

5. The information handling system of claim 3 wherein the optical storage media comprises a write-once CD disc.

6. The information handling system of claim 1 further comprising a write engine operable to receive data from said scan control logic and to modify the write parameters of said operable storage device based on said data received from said scan control logic.

7. The information handling system of claim 6 wherein the optical storage device further comprises a write parameter table having plural sets of write parameters, each set of write parameters associated with a different optical media type, and wherein the can control logic uses said write parameter to determine an optimal write speed for said optical storage media.

8. A method for writing information to an optical storage media, the method comprising:
performing a scan-before-burn routine to assess the quality of said optical storage media and generating data corresponding to the quality of said optical storage media;
using said data generated by said scan-before-burn routine to modify the write speed characteristics of a write engine; and
using said write speed characteristics to optimize writing of data based on the quality of said optical storage media.

9. The method of claim 8 wherein said scan-before-burn routine is performed using media ID parameters stored on said optical storage media.

10. The method of claim 9 wherein said write speed characteristics are stored in a write parameter table and said write parameter table is used by a write engine to optimize the storage of data on said optical storage media.

11. The method of claim 8 wherein the optical media comprises one of a plurality of write-once optical media types, each write-once optical media type having associated write parameters.

12. The method of claim 11 wherein the optical media comprises a write-once DVD disc.

13. The method of claim 11 wherein the optical media comprises a write-once CD.

14. The method of claim 11 wherein the write parameters comprise the write speed.

15. The method of claim 11 further comprising:
determining the optical media type;
determining the write parameters associated with the optical media type; and
adjusting the determined write speed for the optical media type in accordance
with data obtained using said scan-before-burn routine.

16. An optical media storage device comprising:
a laser operable to write information to an optical media with selectable write parameters and to read information from the optical media;
a write engine interfaced with the laser and operable to command the writing of information at selected write parameters and the reading of information; and
scan control logic operable to implement a scan-before-burn procedure to detect the optical quality of an optical storage media and to adjust the write speed of said optical storage device to minimize errors in the transfer of data to said optical storage media.

17. The optical media storage device of claim 16, wherein the scan control logic uses media ID information stored on said optical storage media to perform said scan-before-burn procedure.

18. The information handling system of claim 17, wherein the optical storage media comprises a write-once media.

19. The information handling system of claim 18, wherein the optical storage media comprises a write-once DVD disc.

20. The information handling system of claim 18, wherein the optical storage media comprises a write once CD disc.
